(19) United States
(12) Patent Application Publication
(10) Pub. No.: US 2017/0140399 A1
(43) Pub. Date: May 18, 2017

(54) COMMITMENTS AND FORECASTING MANAGEMENT

(71) Applicant: SAP SE, Walldorf (DE)

(72) Inventors: ZHIQIANG WU, SHANGHAI (CN); MICHEL LOEHDEN, RIMBACH (DE); JANET DOROTHY SALMON, DUDENHOFEN (DE); STEFAN SCHMID, RAUENBERG (DE); HUI WANG, SHANGHAI (CN); ZHONGJIE FANG, SHANGHAI (CN)

(21) Appl. No.: 14/941,519

(22) Filed: Nov. 13, 2015

(51) Int. Cl. G06Q 30/02

(52) U.S. Cl. CPC G06Q 30/0202

(57) ABSTRACT

Methods and system are disclosed that generate forecasting information by aggregating data. In one aspect, an enterprise application may receive a request for a requisition from an operational process. A commitments management application associated with the enterprise application may generate commitment corresponding to the requisition. Data such as operational data, planning data and document data may be aggregated from different data stores. A report including the aggregate data may be generated that may provide forecasting information for an enterprise.

### BACKGROUND

Public organizations or private businesses often operate by regulating financial expenditures to maximize profits. Typically, analyzing planned expenditures and current expenditures may help regulate or control finances. However, there may be scenarios when the actual expenditure may not have incurred, but there may be binder for financial expenditure in future. Typically in such scenarios, there may be a time lag when the actual payment is executed. For example, binders for financial expenditures may be generated for purchase orders and the actual payment is executed upon the delivery of goods or services against the purchase orders. Regulating financial expenditures when considering such binders for financial expenditures may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an environment to generate forecast information by aggregating data, according to an embodiment.

FIG. 2 is a flow diagram illustrating a process to generate forecast information by aggregating data, according to an embodiment.

FIG. 3 is a block diagram illustrating architecture for generating forecasting information by aggregating data, according to an embodiment.

FIG. 4 is a block diagram illustrating business events associated with an operational process, according to an embodiment.

FIG. 5 is a block diagram illustrating a sequence of business events including goods and payment flows, according to an embodiment.

FIG. 6 is a block diagram illustrating a report including aggregated, according to an embodiment.

FIG. 7 is a block diagram showing timeline information associated with business events, according to an embodiment.

FIG. 8 is a block diagram showing forecasting information generated from a report including aggregate data, according to an embodiment.

FIG. 9 is a block diagram of a computer system, according to an embodiment.

### DETAILED DESCRIPTION

Embodiments of techniques related to commitments and forecasting management are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

A requisition may refer to a formal request that may be associated with a purchase, financial operation or transaction or financial process. A purchase order is a document issued by a buyer to a seller indicating agreed prices for products or services the seller will provide to the buyer. Hence purchase orders may be generated for the requisitions. Upon generating the purchase order, a commitment corresponding to the purchase order may be created. In an embodiment, the term “commitment” (also used interchangeably as commitments data) refers to contractual or scheduled expenditure that is not yet reflected in financial accounting, but may lead to actual expenditures in future. A commitments management application may generate and manage such commitments. In an enterprise, operational processes and associated business events may generate commitments at different levels. Commitments data may provide insight into expenditures, revenue reporting, forecasting, etc.

In an embodiment, commitments management may correspond to documenting, versioning and analyzing the commitments data for cost and financial effects. Commitments management involves analyzing commitments at an early stage and accounting them for performing controlling operations. For example, commitments may be generated for Controlling (CO) production orders, production orders, sales orders, cost centers, network activities, maintenance orders, etc. Such commitments data may be aggregated with actual expenditures data and planned expenditures data and a report may be generated. The aggregated data (e.g., commitments data, actual data, planning data, etc.) may be used to generate forecasting information for the enterprise.

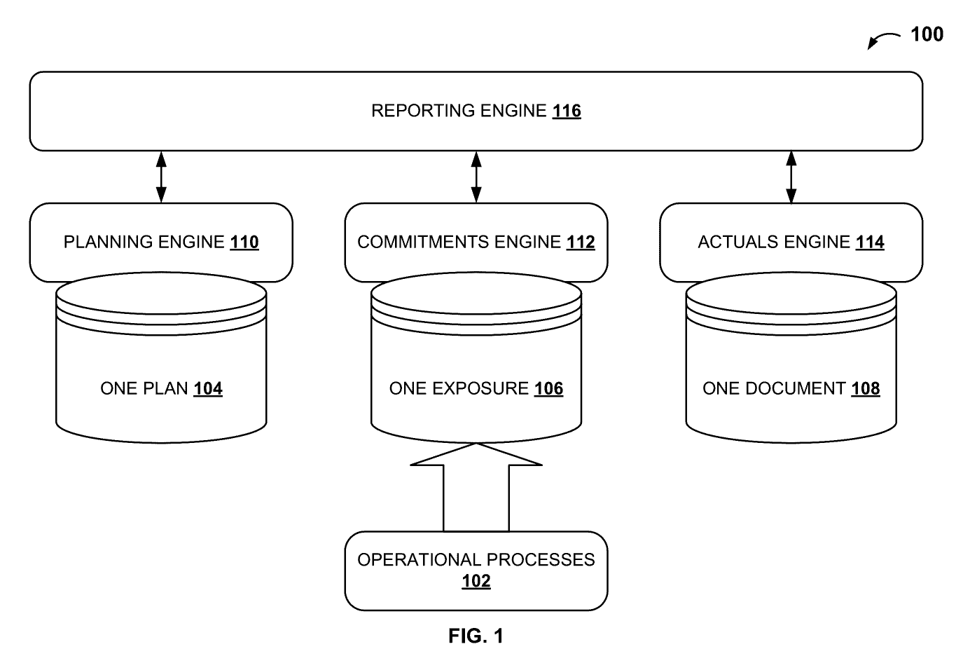

FIG. 1 is a block diagram illustrating an environment 100 to generate forecast information by aggregating data, according to an embodiment. Environment 100 may provide an enterprise application working in conjunction with commitments engine 112 (e.g., a commitments management application). In an embodiment, the enterprise application may communicate with multiple distributed data stores (e.g., 104, 106, 108) over a network (not shown). The data in the data stores (e.g., 104, 106, 108) may be stored in data structures (e.g., table, flat file, etc.) and may be generated from various operational processes 102 and associated business events in an enterprise. The data may correspond to operational data (e.g., data stored in a data store or database also referred to as “One Exposure” 106), planning data (e.g., data stored in a data store or database also referred to as “One Plan” 104), actual or document data (e.g., data stored in a data store or database also referred to as “One Document” 108), etc. The operational processes 102 and the associated business events may generate operational data (e.g., commitments data against purchase requisitions or purchase orders, etc.). The operational data may be accessed by “commitments engine” 112 (also referred to as commitments management engine), the planning data may be accessed by “planning engine” 110 and the document data may be accessed by “actuals engine” 114. The above engines (e.g., 110, 112, and 114) may be configured to work with reporting engine 116 that may generate a report by aggregating data from the data stores (e.g., 104, 106 and 108).

In an embodiment, the enterprise application may receive requisitions (e.g., requisitions for purchasing goods or services) from different operational processes 102 in the enterprise. Upon processing the received requisition, the enterprise application may generate purchase orders. Upon generating the purchase orders, a commitments management application associated with the enterprise application may generate commitments corresponding to the purchase orders or the requisitions. The enterprise application may be configured to determine data (e.g., operational data, planning data, actual data, commitments data, etc.) and centrally generate a report that may be used for forecasting financial expenditures for the enterprise, in an embodiment, the enterprise application may determine operational data stored in the data store (e.g., “One Exposure” 106), document data or actual data stored in the data store (e.g., “One Document” 108) and planning data stored in the data store (e.g., “One Plan” 104). The above data may be determined by using attributes associated with the data. Upon determination, the data may be aggregated and a report including the aggregated data may be generated. The report may include information (e.g., financial budgets and expenditures) that may be provided or be used to generate forecasting information for the enterprise.

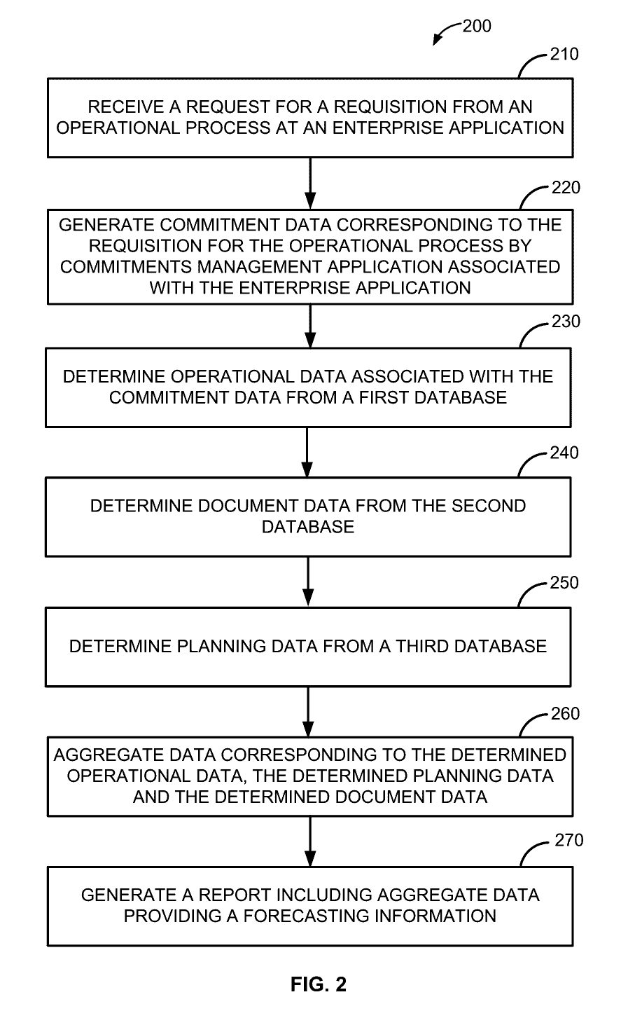

FIG. 2 is a flow diagram illustrating a process 200 to generate forecast information by aggregating data, according to an embodiment. The forecast information may be generated by aggregating data from multiple data sources (e.g., databases, such as relational database, web-based database, in-memory database, etc.) storing different types of data (e.g., operational data, planning data, document data, etc.) in different data structures (e.g., tables, flat files, etc.). In an embodiment, the operational data may be generated by applications and systems (e.g., enterprise resource planning (ERP) applications) in the enterprise. Such operational data may correspond to operations and transactions between business events associated with operational processes in the enterprise. The document data may correspond to data that may be generated by applications and systems and may include the actuals (e.g., information related to actual budgeting, actual expenditure, etc.). The planning data may include the planned data (e.g., information related to planned budgeting, planned expenditures, etc.).

In an embodiment, the data stores may store data that may be generated from multiple operational processes and applications in the enterprise. The data stored in the different databases may be accessed by, for example, an enterprise application that may be deployed in an on premise environment or in a distributed computing environment (e.g., cloud computing environment). The enterprise application may be configured to communicate with the different databases, access the data (e.g., operational data, document data, planning data, etc.) and aggregate data based on a determination. Upon determination, a multidimensional report that may be configured based on inputs from an end user and including the aggregated data may be generated. Such multidimensional reporting may be used for forecasting and prediction of finances (e.g., planned budgets, planned expenditures, actual budgets, actual expenditures, forecasted expenditures, etc.) for the enterprise.

In an embodiment, a request for requisition from an operational process is received at an enterprise application, at 210. In an embodiment, the enterprise application may receive multiple requisitions from multiple operational processes and associated business events in the enterprise. Upon processing the requisition, the enterprise application may generate an order (e.g., purchase order when the requisition corresponds to purchase of service or goods) corresponding to the requisition. Upon generating the purchase order, a commitments management application associated with the enterprise application may generate commitments (also referred to as commitments data). The commitments management application may be integrated to work in conjunction with the enterprise application. The commitments management application may he configured to generate commitments based on the requisitions or the purchase orders.

In an embodiment, commitments management application associated with the enterprise application generates a commitment data corresponding to the requisition for the operational process, at 220. The generated commitments data may be stored as operational data in the database. The commitments data may include identifiers and attributes. In an embodiment, the operational data may be determined and accessed by the enterprise application based on identifiers generated by the commitments management application.

In an embodiment, the enterprise application may be used to generate multidimensional reports. For instance, the enterprise application may access the operational data, the planning data and the document data and generate multidimensional reports. In an embodiment, the enterprise application aggregates data corresponding to the generated commitments by operational data, document data, planning data, etc., associated with the operational processes. In an embodiment, the operational data associated with the commitment data is determined from a first database (e.g., “One Exposure”), at 230. The document data is determined from a second database (e.g., “One document”), at 240. The planning data is determined from a third database (e.g., “One plan”), at 250, in an embodiment, the above-determined data may be extracted or retrieved from the respective databases (e.g., One Exposure, One document and One Plan).

In an embodiment, the operational data, document data, planning data, etc., may be determined by attributes and identifiers associated with the data. For example, the attributes and identifiers may be matched for the determination of the correspondence between the data. Based on such determination, the enterprise application may aggregate the data and generate a report. In an embodiment, data corresponding to the determined operational data, the determined planning data and the determined document data is aggregated, at 260. Upon aggregating the data, the enterprise application generates a report including the aggregated data, at 270. The report including the aggregated data may be used to generate forecasting information for an enterprise.

By way of example, let an operational process be related to procuring a product for the enterprise. In such a scenario, the requisitions may correspond to purchasing (e.g., purchase requisitions) and the enterprise application may generate purchase order corresponding to the requisition. The commitments management application associated with the enterprise application may generate purchase order commitment (also referred to as commitments data) for the purchase order. Such commitments data may be stored in a data store.

In an embodiment, Controlling (CO) may provide with information for management decision-making. CO may facilitate coordination, monitoring and optimization of all processes in an organization. This involves recording both the consumption of production factors and the services provided by an organization. In an embodiment, the CO may be interested in tracking the financial information associated with the enterprise. Such financial information may include budgeting information, expenditure information, etc. The CO may use the enterprise application to generate a report to track such financial information. As explained previously, the enterprise application may generate a report by aggregating data. The data may be aggregated based on the determination of: the operational data (e.g., stored in a first database) associated with the purchase order commitments; document data (e.g., stored in a second database) associated with the one or more purchase orders; and financial planning data (e.g., stored in a third database). Upon determination and aggregating data, the enterprise application may generate a report that may be used to generate forecasting information for the enterprise.

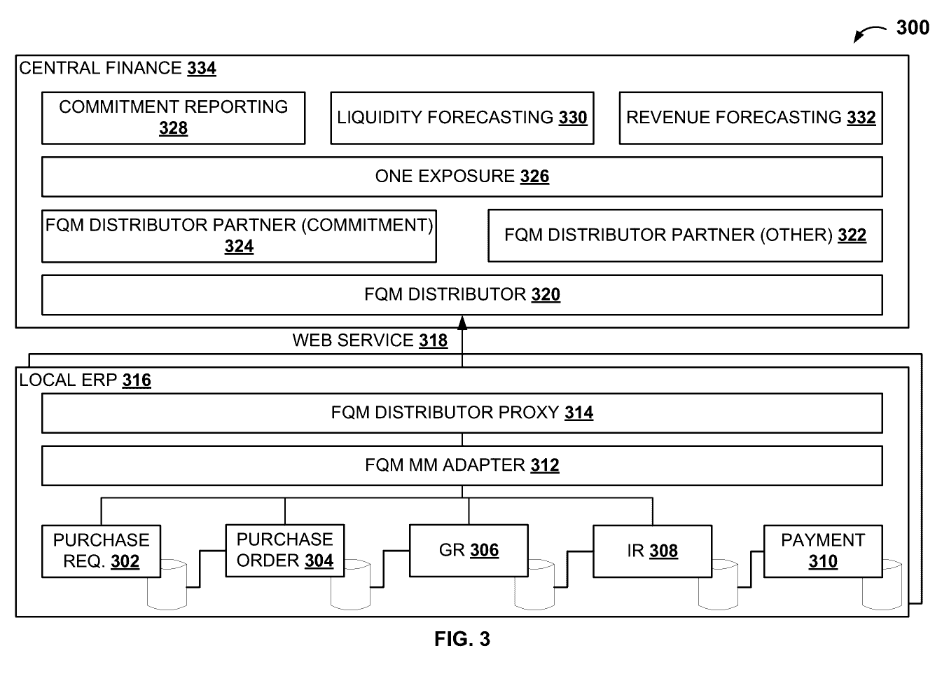

FIG. 3 is a block diagram illustrating architecture 300 for generating forecasting information by aggregating data, according to an embodiment. In an embodiment, an ERP application (e.g., Local ERP 316) may include an integration of modules or software components (e.g., including sequence of computer executable program code) that may be in communication with each other. For example, such software components may include Purchase Requisition 302, Purchase Order 304, Goods Receipt (GR) 306, Invoice Receipt (IR) 308, Payment 310, etc., representing business events (e.g., with specific functionalities). The Financial Quantity Management (FQM) Material Management (MM) Adapter 312 may also be referred to as RWIN may represent accounting interface that may replicate data from operational processes. Additionally, RWIN may convert the data to match the data model associated with the FQM Distributor Proxy 314. The MM may represent logistics components.

In an embodiment, the FQM distributor proxy 314 is a software component associated with FQM Web Service (e.g., 318) that may facilitate data transmission from the ERP application (e.g., 316) to a central system (e.g., central finance 334 including the commitments engine or commitments management application). The FQM Distributor 320 software component is integrated with central finance 334 system that may receive the data transmitted from ERP application 316. Depending on the content of the operational data, FQM Distributor 320 may distribute data received from ERP application 316 to software components FQM Distributor Partner (Other) 322 or FQM Distributor Partner (Commitment) 324. The software components FQM Distributor Partner (Other) 322 or FQM Distributor Partner (Commitment) 324 may process the operational data and passed back the data to FQM Distributor 320 which then store the processed operational data in database (e.g., One Exposure 326).

In an embodiment, the software component FQM Distributor Partner (Commitment) 324 may provide functionalities of commitments management application. The software component FQM Distributor Partner (Commitment) 324 may receive operational data from FQM Distributor 320, process the operational data and passed back the data to FQM Distributor 320 which then store the data in the database (e.g., One Exposure 326) table (e.g., FQM_FLOW). The software components Liquidity Forecasting 330 and Revenue Forecasting 332 may provide forecasting information. The software component Commitment Reporting 328 may facilitate generating a multidimensional report based on aggregated data. The multidimensional report may be used to generate forecasting information.

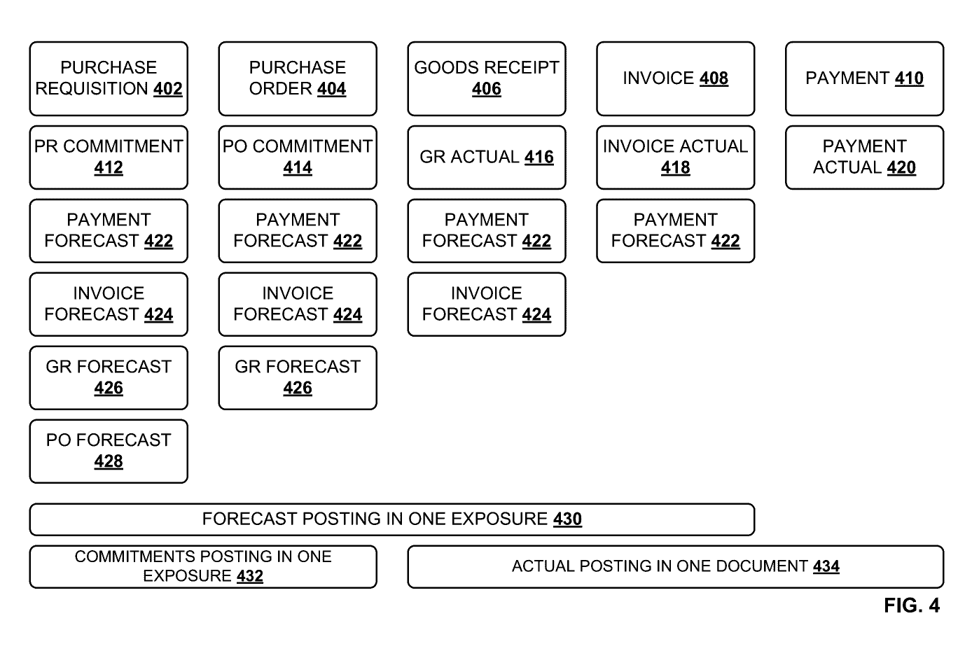

FIG. 4 is a block diagram illustrating business events associated with an operational process, according to an embodiment. In an embodiment, FIG. 4 shows an enablement of the operational process including the business events related to payment for a purchase requisition. In an embodiment, typically the sequence of business events for purchase requisition may include receiving purchase requisition 402, generating purchase order 404, goods receipt 406, invoice 408 and actual payment 410. As shown in FIG. 4, each of the business events may be associated with sub-events, such as PR commitment 412, PO Commitment 414, Payment Forecast 422, Invoice Forecast 424, Goods Receipt Forecast 426, Purchase Order Forecast 428, etc.

As explained previously, upon receiving the purchase requisition at an enterprise application, the purchase order may be generated. The commitments management application associated with the enterprise application may generate purchase order commitment. The sequential events may include generating the Goods Receipt (e.g., GR actual 416), an invoice (e.g., Actual Invoice 418), etc. The payments (e.g., Payment Actual 420) may be processed against the actual invoice 418. In an embodiment, the enterprise application may store the generated commitments in a database (e.g., One Exposure). The enterprise application may access the information related to the actuals (e.g., GR Actual 416, Invoice Actual 418, Payment Actual 420, etc.) from the database, also referred to as One Document and the financial planning data from the database, also referred to as One Plan. In an embodiment, when forecasting information is to be generated, the enterprise application may aggregate data from the above databases (e.g., One Exposure, One Document, One Plan, etc.) and generate a multidimensional report. The multidimensional report may include information such as commitments for purchase requisitions (e.g., commitments posting in one exposure 432), the actual payment (e.g., against the Actual Goods Receipt, Actual Invoice, etc., actual posting in one document 434) and the planned data. Such aggregated data may be used to generate forecasting information (e.g., forecast posting in one exposure 430).

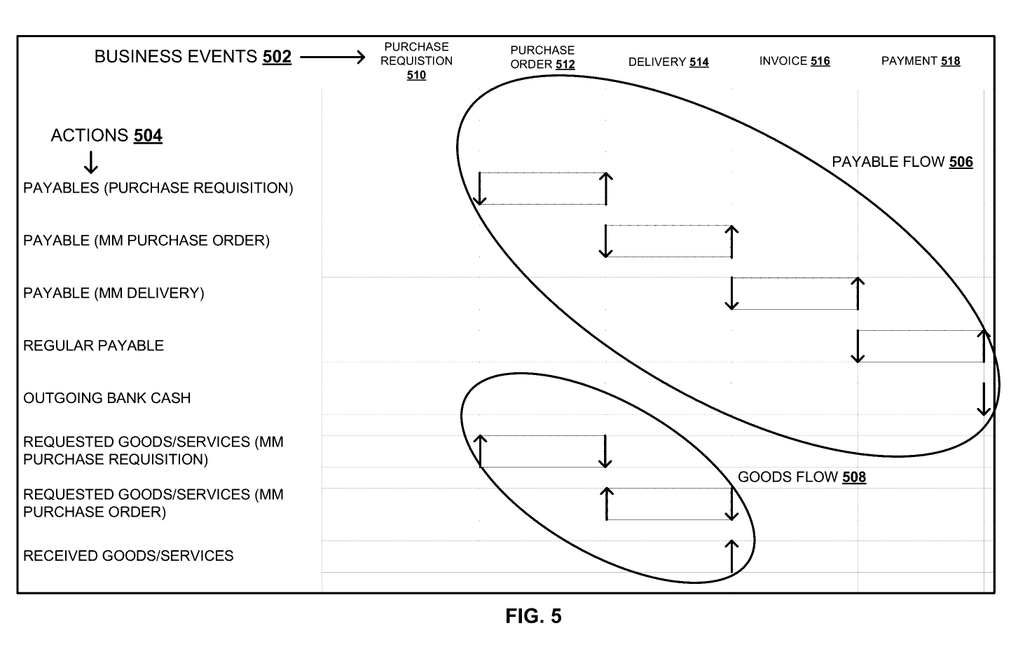

FIG. 5 is a block diagram illustrating a sequence of business events including goods and payment flows, according to an embodiment. By way of illustration, FIG. 5 shows a sequence of business events 502 associated with a purchase requisition (e.g., Purchase Requisition 510, Purchase Order 512, Delivery 514, Invoice 516, Payment 518, etc.), actions 504 (e.g., Payable (Purchase Requisition), Payable (MM Purchase Order), Payable (MM Delivery), Regular Payable, Outgoing Bank Cash, Requested Goods/Services (MM Purchase Requisition), Requested Goods/Services (MM Purchase Order), Received Goods/Services, etc.). FIG. 5 shows the flow of goods (e.g., Goods Flow 508) and information related to flow of payments (e.g., Payable flow 506) that are shown by the upward and downward arrows.

In an embodiment, in payable flow block 506, the flow indicated by the downward arrows against corresponding actions (e.g., payables) may be used to identify that there may be payments or expenditures that may be incurred or executed in future. The flow indicated by the upward arrows against corresponding actions. In goods flow block 508, the flow indicated by upward arrow against corresponding action (e.g., requested goods) may be used to identify that a purchase order was raised. Likewise, the upward and downward arrows in corresponding flow blocks (e.g., 506 and 508) against corresponding actions (504) may be used to identify execution of specific business events (502).

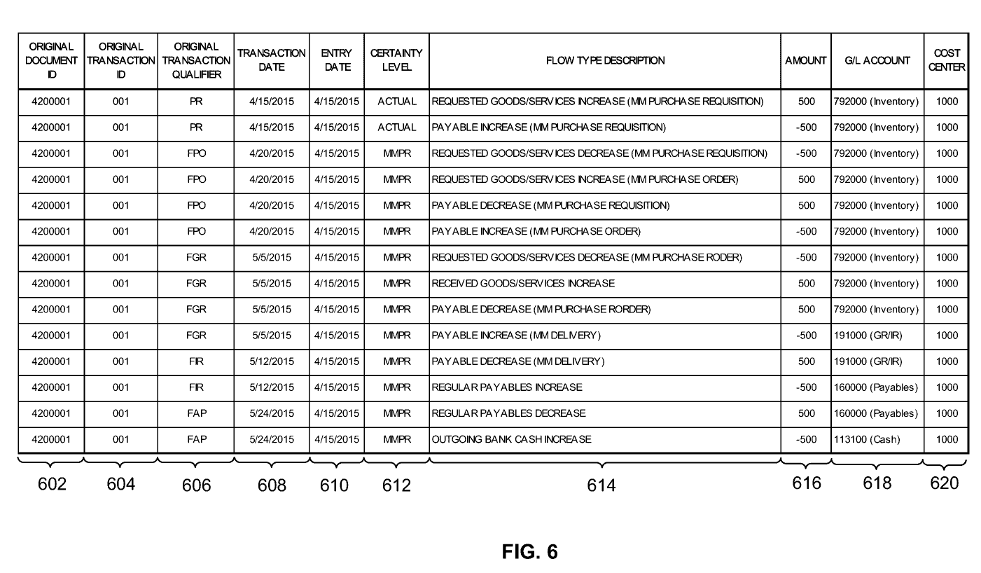

FIG. 6 is a block diagram illustrating a report including aggregated, according to an embodiment. By way of illustration, FIG. 6 shows a table including data associated with aggregated data, such as commitments data, actual data and forecasting data. The columns of the table include information associated with Original Document ID 602, Original Transaction ID 604, Original Transaction Qualifier 606, Transaction Date 608, Entry Date 610, Certainty Level 612, Flow Type Description 614, Amount 616, G/L Account 618, Cost Center 620, etc. The data corresponding to the rows (e.g., first two rows) may include information associated with commitments. The data corresponding to the rows (e.g., after the first two rows) may include forecasting information that may be used for planning future expenditures or business activities within the enterprise.

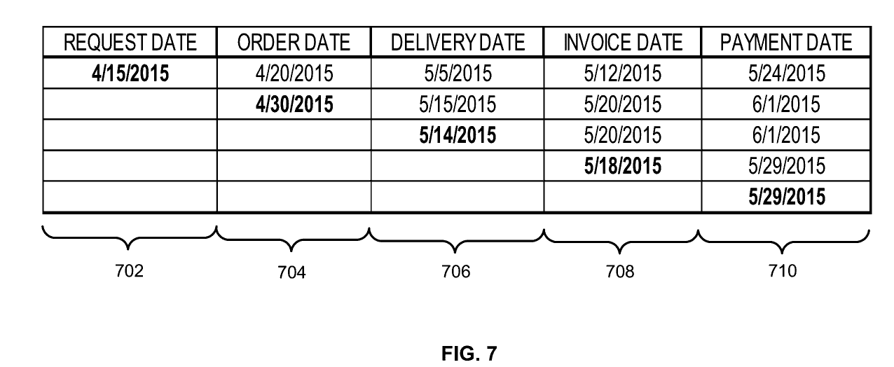

FIG. 7 is a block diagram showing timeline information associated with business events, according to an embodiment. By way of illustration, FIG. 7 shows a table that includes information associated with business events (e.g., Purchase Requisition, Purchase Order, Goods Receipt, Invoice, Payment, etc.). The columns of table in FIG. 7 include timeline information such as Request Date 702, Order Date 704, Delivery Date 706, Invoice Date 708, Payment Date 710, etc., associated with the purchase. As shown, the request date (702) for a requisition is ‘Apr. 15, 2015’, indicated by the first row and first column in the table, while the payment date (710) is ‘May 29, 2015’, indicated by the last row and last column in the table. The dates shown in the other columns (704, 706 and 708) indicate the time period for execution of specific business events (e.g., Order, Delivery, Invoice, etc.) before the actual payment is executed.

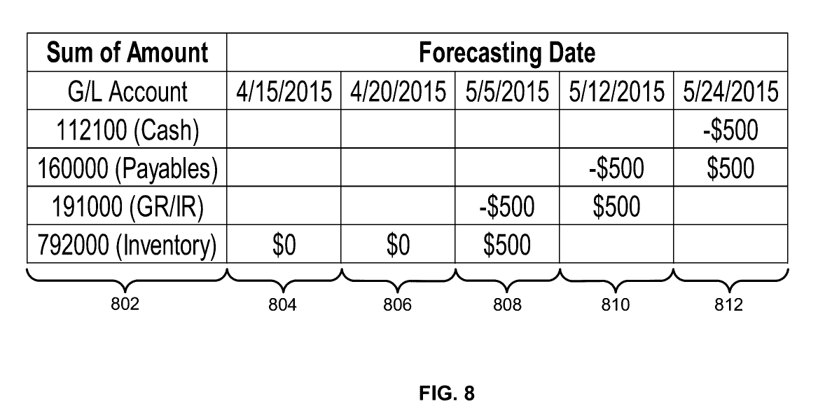

FIG. 8 is a block diagram showing forecasting information generated from a report including aggregate data, according to an embodiment. By way of illustration, FIG. 8 shows a report that may be used to generate forecasting information. The report includes information such as Sum of Amount/(General Ledger) GL Account 802 and Forecasting Dates (e.g., 804, 806, 808, 810, 812). For example, a cash forecasting may be used to predict or forecast information for a cash payment request of $500 on account number 112100 on May 24, 2015. Payable forecasting information may be used to predict or forecast information for an increase of $500 on Payables account number 191000 on May 12, 2015, which will be processed on May 24, 2015. An inventory forecasting information may be used to predict or forecast information for an increase of $500 on the inventory account number 792000 on May 5, 2015.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may he implemented using Java, C++, or other object-oriented programming language and development tools. Another embodiment may be implemented in hard-wired circuitry in place of, or in combination with machine-readable software instructions.

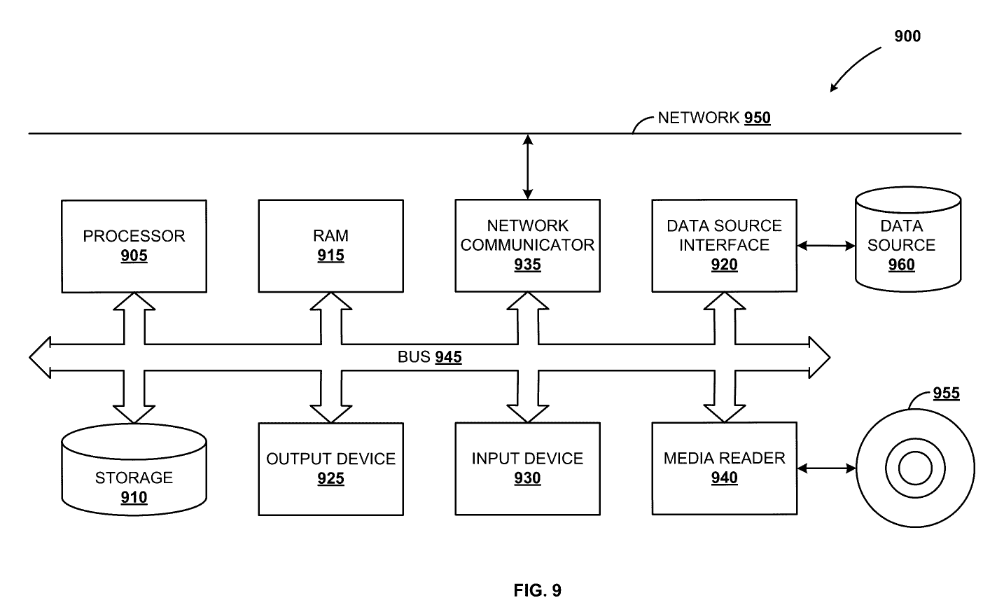

FIG. 9 is a block diagram of an exemplary computer system 900, according to an embodiment. Computer system 900 includes processor 905 that executes software instructions or code stored on computer readable storage medium 955 to perform the above-illustrated methods. Processor 905 can include a plurality of cores. Computer system 900 includes media reader 940 to read the instructions front computer readable storage medium 955 and store the instructions in storage 910 or in random access memory (RAM) 915. Storage 910 provides a large space for keeping static data where at least some instructions could be stored for later execution. According to some embodiments, such as some in-memory computing system embodiments, RAM 915 can have sufficient storage capacity to store much of the data required for processing in RAM 915 instead of in storage 910. In some embodiments, all of the data required for processing may be stored in RAM 915. The stored instructions may be further compiled to generate other representations of the instructions and dynamically stored in RAM 915. Processor 905 reads instructions from RAM 915 and performs actions as instructed. According to one embodiment, computer system 900 further includes output device 925 (e.g., a display) to provide at least some of the results of the execution as output including, but not limited to, visual information to users and input device 930 to provide a user or another device with means for entering data and/or otherwise interact with computer system 900. Each of these output devices 925 and input devices 930 could be joined by one or more additional peripherals to further expand the capabilities of computer system 900. Network communicator 935 may be provided to connect computer system 900 to network 950 and in turn to other devices connected to network 950 including other clients, servers, data stores, and interfaces, for instance. The modules of computer system 900 are interconnected via bus 945. Computer system 900 includes a data source interface 920 to access data source 960. Data source 960 can be accessed via one or more abstraction layers implemented in hardware or software. For example, data source 960 may be accessed by network 950. In some embodiments data source 960 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, sonic concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to he determined by the following claims, which are to be interpreted in accordance with established doctrines of claim construction.

What is claimed is:

1. A computer implemented method to generate forecast information by aggregating data, comprising:
receiving a request for one or more requisitions from one or more operational processes at an enterprise application;
generating one or more commitments corresponding to the one or more requisitions for the one or more operational processes by a commitments management application associated with the enterprise application;
aggregating data corresponding to the generated one or more commitments, by determining:
operational data associated with the one or more commitments from a first database;
document data from a second database; and
planning data from a third database; and
generating a report including the aggregated data, the report providing forecast information for an enterprise.

2. The computer implemented method of claim 1 further comprising: when an operational process from the one or more operational processes corresponds to a financial process, generating one or more purchase order commitments corresponding to one or more purchase orders, wherein the one or more purchase order commitments are associated with purchase order value, delivery date and account assignment information.

3. The computer implemented method of claim 1, further comprising: when the operational process from the one or more operational processes corresponds to the financial process, the planning data corresponds to a financial planning data generated by one or more financial planning applications in the enterprise.

4. The computer implemented method of claim 1, wherein the document data is generated by one or more applications in the enterprise.

5. The computer implemented method of claim 1, wherein the operational data is determined by one or more identifiers associated with the commitments generated by the commitments management application.

6. The computer implemented method of claim 1, wherein the document data is determined by one or more attributes associated with one or more documents related to the financial process.

7. A computer system to generate forecast information by aggregating data, comprising:
a processor; and
one or more memory devices communicatively coupled with the processor and storing instructions related to:
receive a request for one or more requisitions from one or more operational processes at an enterprise application;
generate one or more commitments corresponding to the one or more requisitions for the one or more operational processes by a commitments management application associated with the enterprise application;
aggregate data corresponding to the generated one or more commitments, by determining;
operational data associated with he one or more commitments from a first database;
document data from a second database; and
planning data from a third database; and
generate a report including the aggregated data, the report providing forecast information for an enterprise.

8. The computer system of claim 7, further comprising: when an operational process from the one or more operational processes corresponds to a financial process, generating one or more purchase order commitments corresponding to one or more purchase orders, wherein the one or more purchase order commitments are associated with purchase order value, delivery date and account assignment information.

9. The computer system of claim 7, further comprising: when the operational process from the one or more operational processes corresponds to the financial process, the planning data corresponds to a financial planning data generated by one or more financial planning applications in the enterprise.

10. The computer system of claim 7, wherein the document data is generated by one or more applications in the enterprise.

11. The computer system of claim 7, wherein the operational data is determined by one or more identifiers associated with the commitments generated by the commitments management application.

12. The computer system of claim 7, wherein the document data is determined by one or more attributes associated with one or more documents related to the financial process.

13. A non-transitory computer readable storage medium tangibly storing instructions, which when executed by a computer, cause the computer to execute operations, comprising:
receive a request for one or more requisitions from one or more operational processes at an enterprise application;
generate one or more commitments corresponding to the one or more requisitions for the one or more operational processes by a commitments management application associated with the enterprise application;
aggregate data corresponding to the generated one or more commitments, by determining:
operational data associated with the one or more commitments from a first database;
document data from a second database; and
planning data from a third database; and
generate a report including the aggregated data, the report providing forecast information for an enterprise.

14. The non-transitory computer readable storage medium of claim 13, further comprising: when an operational process from the one or more operational processes corresponds to a financial process, generating one or more purchase order commitments corresponding to one or more purchase orders, wherein the one or more purchase order commitments are associated with purchase order value, delivery date and account assignment information.

15. The non-transitory computer readable storage medium of claim 13, further comprising: when the operational process from the one or more operational processes corresponds to the financial process, the planning data corresponds to a financial planning data generated by one or more financial planning applications in the enterprise.

16. The non-transitory computer readable storage medium of claim 13, wherein the document data is generated by one or more applications in the enterprise application.

17. The non-transitory computer readable storage medium of claim 13, wherein the operational data is determined by one or more identifiers associated with the commitments generated by the commitments management application.

18. The non-transitory computer readable storage medium of claim 13, wherein the document data is determined by one or more attributes associated with one or more documents related to the financial process.
